(19) United States
(12) Patent Application Publication
(10) Pub. No.: US 2024/0310547 A1
(43) Pub. Date: Sep. 19, 2024

(54) SYSTEM AND METHOD FOR SEISMIC INVERSION AND WAVELET ESTIMATION

(71) Applicant: CHEVRON U.S.A. INC., San Ramon, CA (US)

(72) Inventors: Un Young Lim, Katy, TX (US); Ke Wang, Sugar Land, TX (US); Reynaldo Cardona, Katy, TX (US)

(73) Assignee: CHEVRON U.S.A. INC., San Ramon, CA (US)

(21) Appl. No.: 18/591,065

(22) Filed: Feb. 29, 2024

Related U.S. Application Data
(60) Provisional application No. 63/490,562, filed on Mar. 16, 2023.

(51) Int. Cl. G01V 1/50; E21B 49/00

(52) U.S. Cl. CPC G01V 1/50; E21B 49/00; G01V 2210/6222; G01V 2210/66

(57) ABSTRACT

A method is described for seismic inversion and wavelet estimation including uncertainty quantification. The method uses bootstrapping and deep neural networks to generate an ensemble of realizations that are analyzed to quantify uncertainty. The method is executed by a computer system.

### CROSS-REFERENCE TO RELATED APPLICATIONS

This application claims the benefit of US Provisional Patent Application 63/490,562, entitled System and Method for Seismic Inversion and Wavelet Estimation, filed Mar. 16, 2023, the entirety of which is incorporated herein by reference.

### STATEMENT REGARDING FEDERALLY SPONSORED RESEARCH OR DEVELOPMENT

Not applicable.

### TECHNICAL FIELD

The disclosed embodiments relate generally to techniques for seismic inversion. In particular, the techniques provide information on uncertainty in the seismic inversion.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties.

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

Seismic data is processed to create seismic images that can be interpreted to identify subsurface geologic features including hydrocarbon deposits. Seismic inversion, specifically Amplitude Variation with Angle (AVA) inversion, is essential for estimating the acoustic and elastic properties of the target layers in reservoir conditions. However, the uneven presence of noise in the data gathered from different reflection angles can introduce uncertainty into the estimations, known as data uncertainty. Nonetheless, the industry typically focuses on model uncertainty (i.e., the distribution of a range of models can fit the observations equally well). Model uncertainty is addressed through sampling inference methods like Markov Chain Monte Carlo (MCMC) modeling.

The ability to define the location of rock and fluid property changes in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There is a need to address data uncertainty and model uncertainty in seismic inversion.

### SUMMARY

In accordance with some embodiments, a method of seismic inversion and wavelet estimation including uncertainty quantification is disclosed. The method uses bootstrapping and deep neural networks to generate an ensemble of realizations that are analyzed to quantify uncertainty. The computer-implemented method for seismic inversion with uncertainty quantification will receive well logs (at least one of P-wave velocity (Vp), S-wave velocity (Vs), density (ρ), and acoustic impedance (AI)); bootstrapping a plurality of synthetic angle gathers generated by forward seismic modeling with the well logs, each of the plurality of synthetic angle gathers having an individual angle configuration of a random selection of angles; and training neural networks using the well logs and the bootstrapped angle gathers as training pairs to build an ensemble of neural networks. The method will then receive a recorded seismic dataset; prepare seismic angle gathers from the recorded seismic dataset using each of the individual angle configurations to create an ensemble of seismic angle gathers; present each of the ensemble of seismic angle gathers to a member of the ensemble of neural networks that was trained with a matching individual angle configuration to generate an ensemble of inversion results; and quantify uncertainty in the ensemble of inversion results. The uncertainty is quantified by finding an average inversion result and a standard deviation of the ensemble of inversion results. The method may produce inversion results that are P-wave velocity (Vp), S-wave velocity (Vs), density (ρ), acoustic impedance (AI), Vp/Vs ratio, Young's Modulus (E), and/or Poisson's ratio (v). The method may be used to estimate wavelets.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates an example system for seismic inversion;

FIG. 2 illustrates an example method for seismic inversion;

FIG. 3 illustrates an embodiment of a method for seismic inversion with uncertainty quantification;

FIG. 4 illustrates an example step of an embodiment of a method for seismic inversion with uncertainty quantification;

FIG. 5 illustrates an example step of an embodiment of a method for seismic inversion with uncertainty quantification;

FIG. 6 illustrates a result of a conventional seismic inversion of synthetic seismic data;

FIG. 7 illustrates a result of a present embodiment of seismic inversion of synthetic seismic data;

FIG. 8 illustrates a result of a present embodiment of seismic inversion of synthetic seismic data;

FIG. 9 illustrates a result of a present embodiment of seismic inversion of synthetic seismic data;

FIG. 10 illustrates a result of a present embodiment of seismic inversion of synthetic seismic data;

FIG. 11 illustrates a result of a present embodiment of seismic inversion of synthetic seismic data;

FIG. 12 illustrates a result of a present embodiment of seismic inversion of synthetic seismic data;

FIG. 13 illustrates a result of a present embodiment of seismic inversion of synthetic seismic data;

FIG. 14 illustrates a result of a present embodiment of seismic inversion of synthetic seismic data showing the prediction of uncertainty;

FIG. 15 compares results of a present embodiment of seismic inversion with the true answer;

FIG. 16 compares results of a present embodiment of seismic inversion with the true answer; and

FIG. 17 compares results of a present embodiment of wavelet estimation with a conventional method.

Like reference numerals refer to corresponding parts throughout the drawings.

### DETAILED DESCRIPTION OF EMBODIMENTS

Described below are methods, systems, and computer readable storage media that provide the seismic inversion. The present invention is an innovative solution to the long-standing issue of data uncertainty in seismic inversion. By combining Bootstrapping and DNN techniques, the method generates more accurate and consistent results and quantifies the uncertainty in the data. It allows quantification of data uncertainty and model uncertainty. By performing seismic inversion in this way, the method is able to quantify uncertainty of acoustic and elastic properties such as P-wave velocity (Vp), S-wave velocity (Vs), density (ρ), acoustic impedance (AI) and the Vp/Vs ratio; uncertainty of geomechanical properties such as Young's modulus (E) and Poisson's ratio (v); and uncertainty of stress calculation such as vertical stress (Sv), minimum horizontal stress (S_{Hmin}), and maximum horizontal stress (S_{Hmax}). This invention has significant value for the oil and gas industry, as it can improve decision-making and reduce costs by providing more accurate predictions of reservoir properties. It can also provide a more comprehensive understanding of uncertainty, which is essential for better risk assessment and asset management.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

The methods and systems of the present disclosure may, in part, use one or more models that are machine-learning algorithms. These models may be supervised or unsupervised. Supervised learning algorithms are trained using labeled data (i.e., training data) which consist of input and output pairs. By way of example and not limitation, supervised learning algorithms may include classification and/or regression algorithms such as neural networks, generative adversarial networks, linear regression, etc. Unsupervised learning algorithms are trained using unlabeled data, meaning that training data pairs are not needed. By way of example and not limitation, unsupervised learning algorithms may include clustering and/or association algorithms such as k-means clustering, principal component analysis, singular value decomposition, etc. Although the present disclosure may name specific models, those of skill in the art will appreciate that any model that may accomplish the goal may be used.

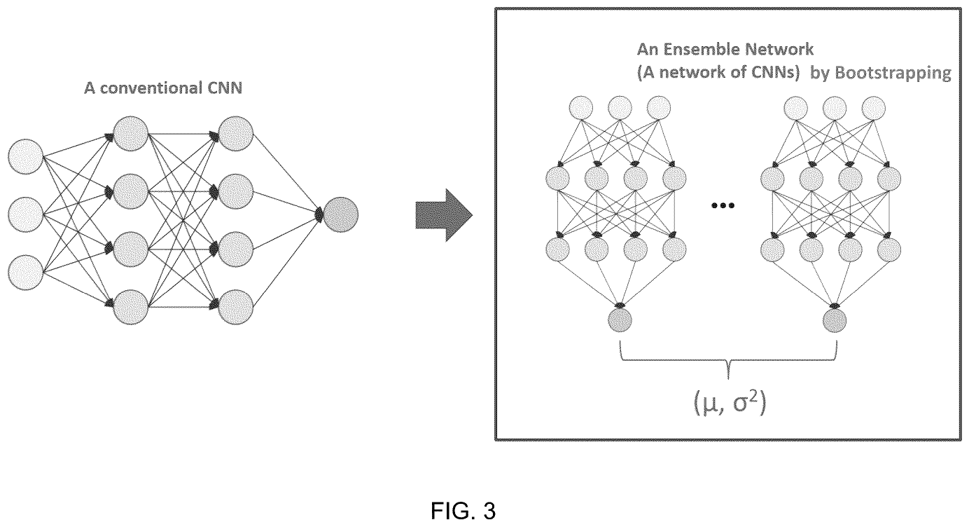

As can be seen in FIG. 3, the present disclosure does not use a conventional convolutional neural network (CNN) but rather builds an ensemble network. This is accomplished by using Bootstrapping. Bootstrapping uses random sampling from an input dataset with replacement during the sampling, generating many sets of bootstrapped input data, to infer multiple results that can then be measured statistically. The results of the network of CNNs allows quantification of the uncertainty (population mean μ and standard deviation σ) in the results of the CNNs.

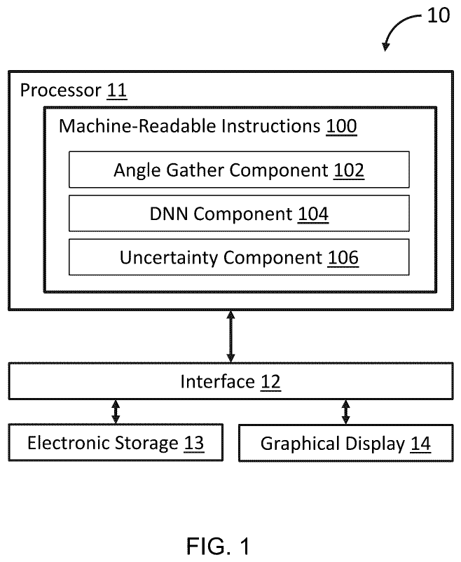

The methods and systems of the present disclosure may be implemented by a system and/or in a system, such as a system 10 shown in FIG. 1. System 10 may include one or more of a processor 11, an interface 12 (e.g., bus, wireless interface), an electronic storage 13, a graphical display 14, and/or other components.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store information relating to input seismic data, and/or other information. For example, the electronic storage 13 may store information relating to output subsurface models, uncertainty, and/or other information. The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may include one or more non-transitory computer readable storage medium storing one or more programs. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

The graphical display 14 may refer to an electronic device that provides visual presentation of information. The graphical display 14 may include a color display and/or a non-color display. The graphical display 14 may be configured to visually present information. The graphical display 14 may present information using/within one or more graphical user interfaces. For example, the graphical display 14 may present information relating to seismic data, angle gathers, angle stacks, model uncertainty, data uncertainty, and/or other information.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate seismic inversion. The machine-readable instructions 100 may include one or more computer program components. The machine-readable instructions 100 may include an angle stack component 102, a deep neural network (DNN) component 104, an uncertainty component 106, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for case of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the angle gather component 102 may be configured to bootstrap angle gathers.

The DNN component 104 may be configured to use a deep neural network for each of the bootstrapped angle gather sets to generate a realization for each set.

The uncertainty component 106 may be configured to determine the uncertainty inherent in the realizations from DNN component 104.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

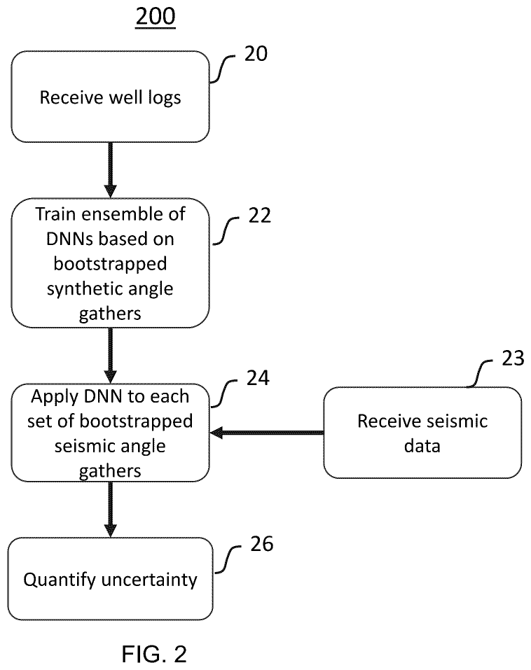

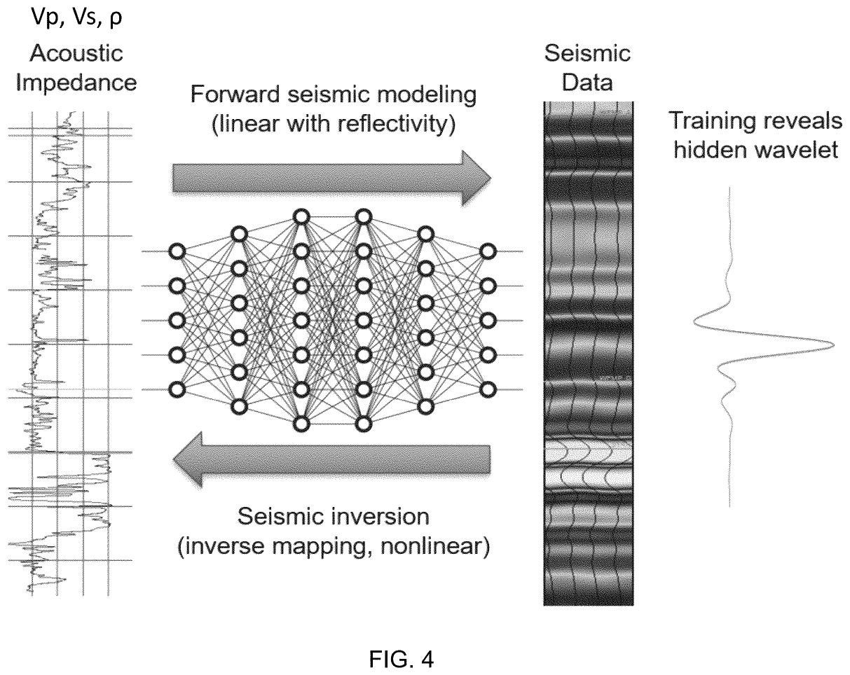

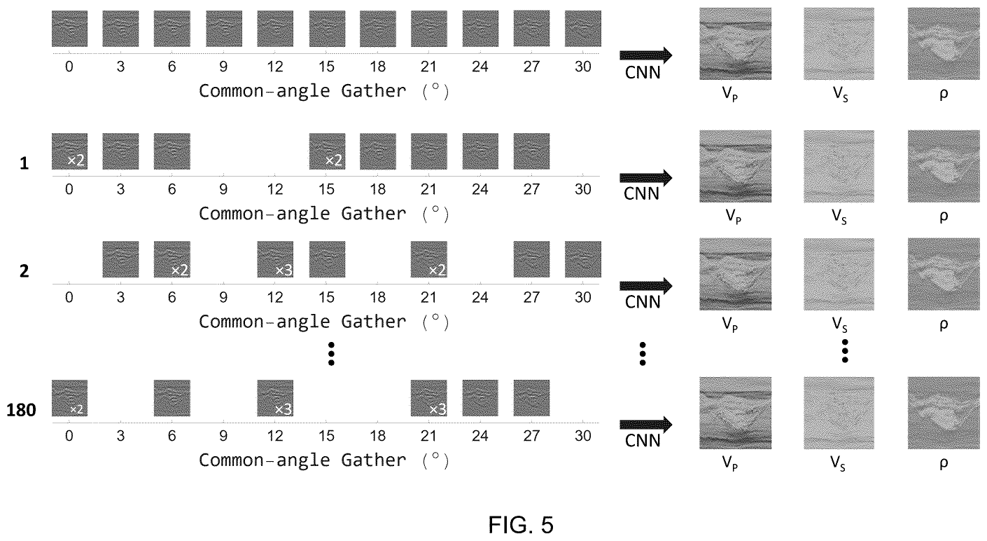

FIG. 2 illustrates an example process 200 for seismic inversion. At step 20, well logs including P-wave and S-wave velocities and density are received. At step 22, the present invention applies bootstrapping to randomly select some angle gathers to generate bootstrapped realizations. This generates an ensemble of high-resolution predictions combining bootstrapping of input data. The method uses a physics-based machine learning approach, which is different from conventional machine learning methods that use input and output observations as training pairs. Instead, the method generates one element of the training pair directly from another input element of the training pair using well-known physics. For example, one element is a set of well-logs consisting of P-wave and S-wave velocities and density. An embodiment may use the well-known Zoeppritz equation to forward-model seismic reflectivity at different angles (i.e., Amplitude Variation with Angle, AVA). Therefore, a training pair is the set of well-logs and synthetic seismic traces at different reflectivity angles, which are directly forward modeled from corresponding well-logs, as shown in FIG. 4. Compute time for this step is very efficient because the training time remains constant regardless of the size of the 3D data volume. The method bootstraps angle gathers to prepare several different training sets with varying configurations of angle. For example, the first, second, and Nth bootstrapped realizations of the angle stack could be set like {0, 0, 3, 6, 15, 15, 18, 21, 24, 27}—1st set, {3, 6, 6, 12, 12, 12, 15, 21, 21, 27, 30}—2nd set, and {0, 0, 6, 12, 12, 12, 21, 21, 21, 24, 27}—Nth set. Specific angles may be selected multiple times or not even selected since bootstrapping is the algorithm for random and replacement selection. In an embodiment, the method builds an individual DNN after training between well-logs and one bootstrapped angle-gather (e.g., 1st set). Then the method builds another DNN by training between well-logs with another bootstrapped angle-gather (e.g., 2nd set) and continues this process until it has built the Nth DNN. An example of this can be seen in FIG. 5.

Step 23 receives seismic data that are supplied to step 24. After step 22 has built all N (e.g., 180) DNNs, step 24 prepares input seismic angle gathers using the individual angle configurations used for the inference/predication of target rock properties (e.g., P- and S-wave velocities, and density) with each of the trained DNN that were established with synthetic angle gathers described in step 22 (i.e., by using each trained DNN for generating an individual prediction set with a seismic angle gather that prepared with the same angle configuration of the synthetic gather used for training stage in step 22). Notice the input seismic angle gathers are different from the synthetic angle gathers we used for the training of DNNs but have the same angle configuration as the synthetic gathers. These seismic data (collected from a field) are used for prediction. Each set of prepared/configured field seismic data is input to the corresponding DNN to obtain an individual prediction set of rock properties such as P-wave and S-wave velocities and density. Each DNN produces one realization of the prediction set of rock properties. This generates an ensemble of predicted rock properties.

At step 26, the multiple realizations of the predicted rock properties are used to quantify uncertainty. To quantify data uncertainty, the method analyzes all predictions of target parameters from the prediction ensemble to define the average model and the standard deviation of the output model distributions.

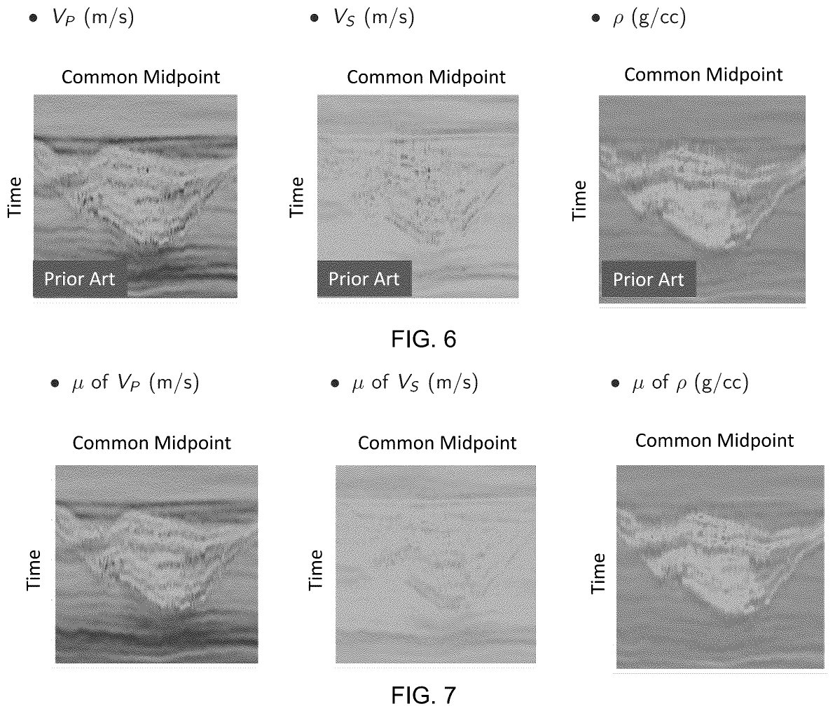

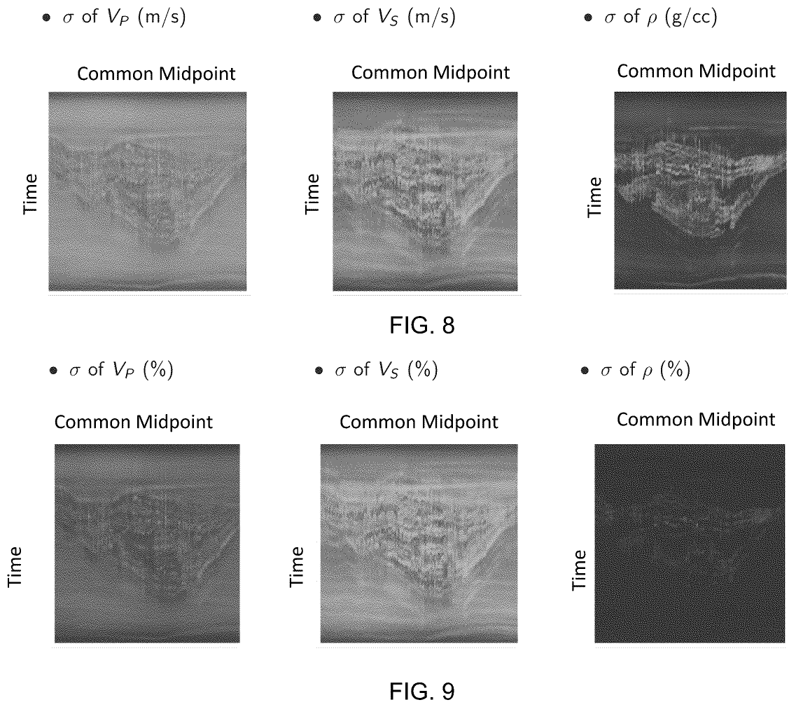

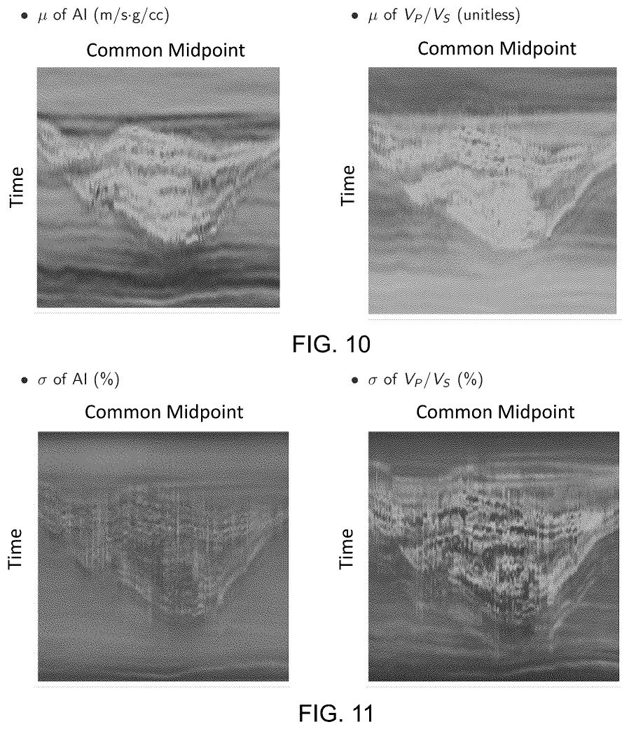

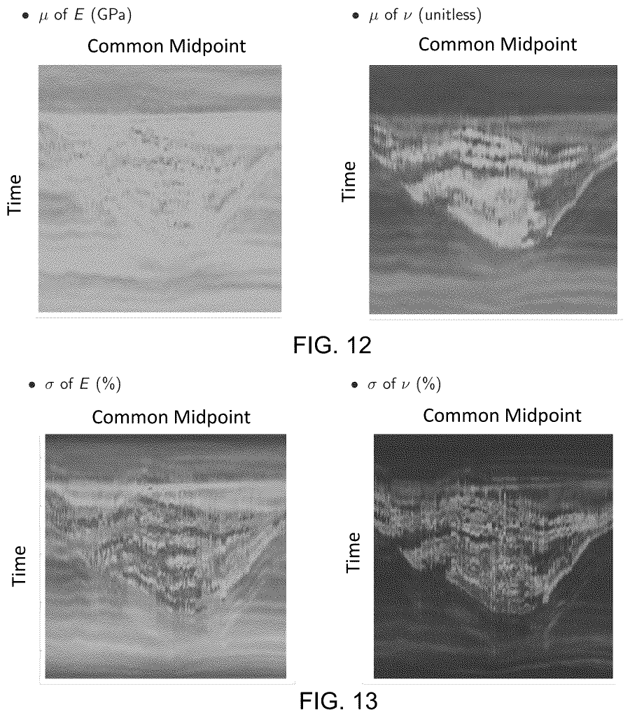

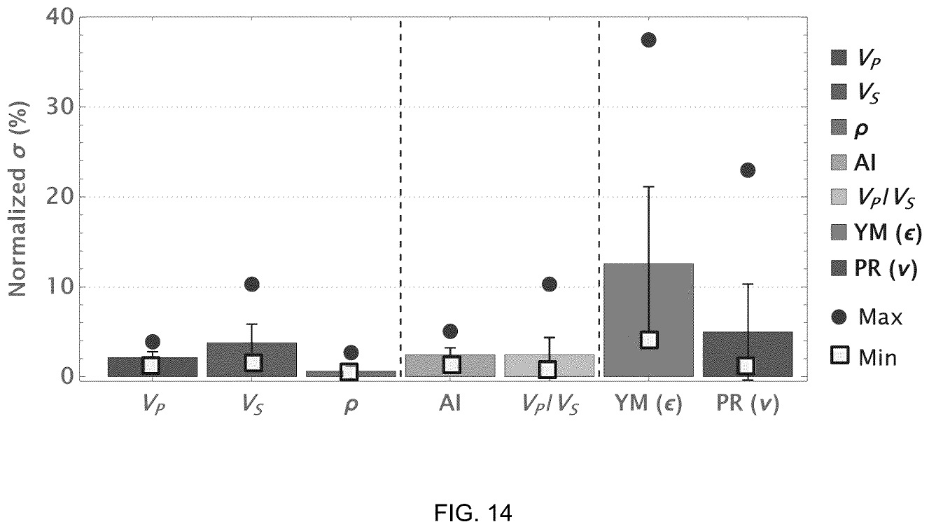

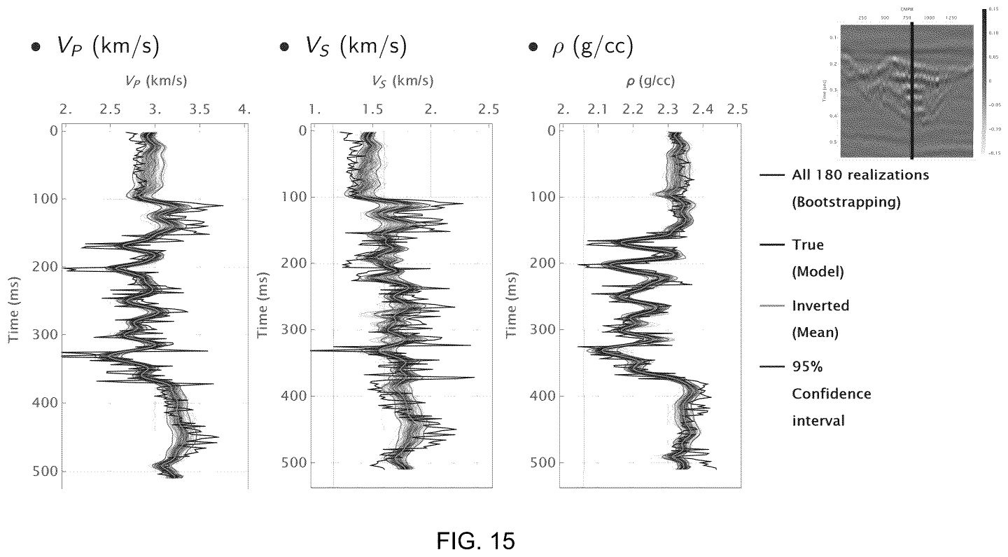

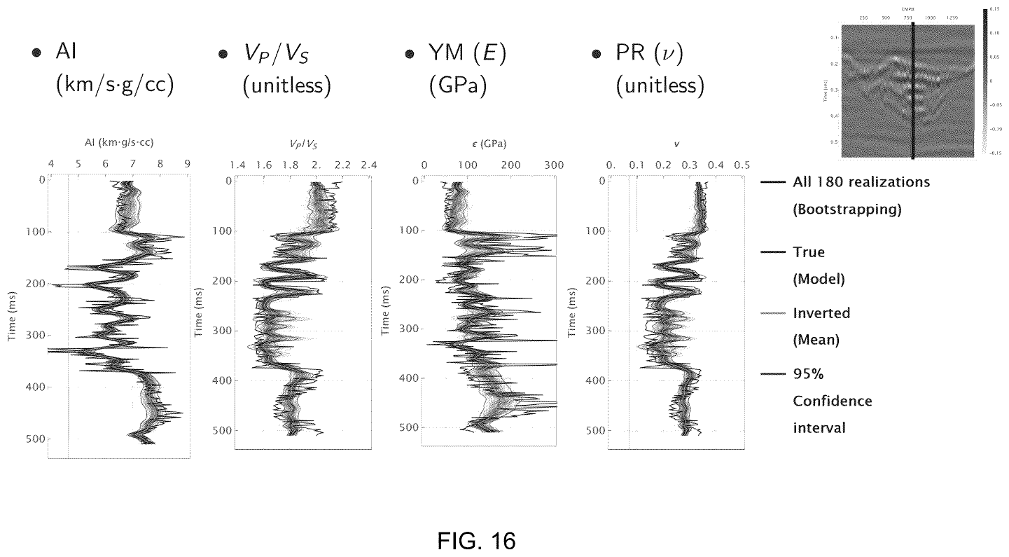

Examples of results of method 200 may be seen in FIGS. 7 through 16, and compared with prior art results in FIG. 6. FIG. 6 shows a prior art inversion result for Vₚ, Vₛ, and density (ρ) inverted from a synthetic seismic dataset, for which the actual acoustic and clastic properties are known. FIG. 7 shows the result of method 200, where the average model (μ) of each of Vₚ, Vₛ, and density (ρ) is shown. The standard deviation (σ) of the results for Vₚ, Vₛ, and density (ρ) can be seen as values in FIG. 8 and as a percentage in FIG. 9. The standard deviation allows those of skill in the art to recognize regions in the image that have high uncertainty, meaning that the images in those regions may be incorrect. FIG. 10 shows the μ for the acoustic impedance (AI) inversion results and the μ for the Vₚ/Vₛ ratio. FIG. 11 shows the σ for the AI inversion results and the μ for the Vₚ/Vₛ ratio. FIG. 12 shows the μ for the Young's modulus (E) and Poisson's ratio (v). FIG. 13 shows the σ for E and v. FIG. 14 shows another way to look at the standard deviation. FIG. 15 and FIG. 16 compare the results of method 200 Vₚ, Vₛ, p, AI, Vₚ/Vₛ ratio, E, and v for one vertical line against the true answer, which is known because this is being done for a synthetic model and dataset.

All FIGS. 7-16 show examples of the possible graphical displays that may be produce by method 200.

This method is unique because it combines Bootstrapping and DNN for the seismic inversion problem. The method provides several advantages, such as quantification of data uncertainty, reduction of prediction noise from Bootstrapping, and accurate and fast end-to-end inversion from DNN. Most importantly, the captured uncertainty is a new type of uncertainty (i.e., data uncertainty) that differs from the model uncertainty the industry typically focuses on. Finally, the method provides a complete understanding of the uncertainty in seismic inversion if we combine the defined data uncertainty with model uncertainty derived from other methods like MCMC. This method is much faster computationally than conventional MCMC inversion, both for 2D inversion where it may be more than twice as fast and for 3D inversion where it can be over 1000 times as fast.

This method may also be used for Bootstrapping wavelet estimation, which is related to seismic inversion. Wavelet estimation is essential in generating pairs of synthetic reflectivity and seismic traces to train a Deep Neural Network (DNN) in modern machine learning applications for seismic inversion. However, the selection of appropriate wells is critical since the quality of synthetic reflectivity generated from logs directly depends on the selected wells. Experienced practitioners typically determine the well selection, which can be a subjective process.

To address this issue, the proposed DNN Bootstrapping workflow effectively selects wells to estimate the best wavelets for inversion. Furthermore, this workflow can quantitatively define data uncertainty due to the differences in the quality of the well logs used for wavelet estimation.

The workflow consists of three primary steps:
Bootstrapping of wells: This step applies Bootstrapping to randomly select wells from a given list and generate bootstrapped realizations consisting of necessary logs of the selected well for generating synthetic reflectivity. Each realization is paired with the corresponding seismic trace and passed to the DNN as an individual input for wavelet estimation. Multiple wavelets are generated from the bootstrapped realizations and used to select the best wavelet and quantify data uncertainty.
DNN: The DNN is trained using one of the bootstrapped pairs of well-logs and seismic traces, called one realization, to estimate an instance of the wavelet.
Ensemble of wavelets: This step involves analyzing all estimated wavelets and cross-correlation values between synthetic reflectivity and corresponding seismic traces in the ensemble set to define the best wavelet and data uncertainty.

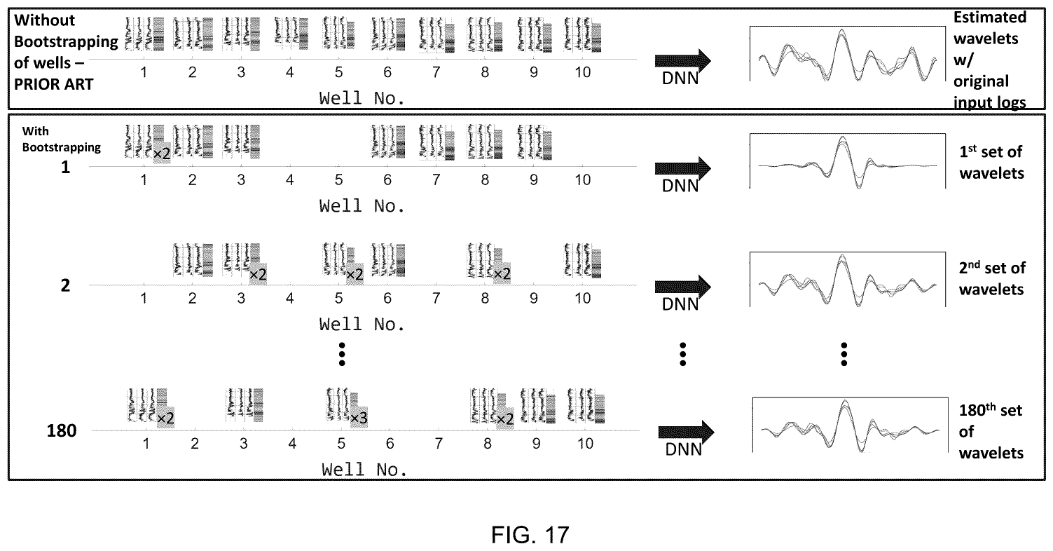

This wavelet estimation is demonstrated in FIG. 17. This DNN Bootstrapping workflow for wavelet estimation improves the accuracy and reliability of the seismic inversion process.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for seismic inversion with uncertainty quantification, comprising:
a. receiving well logs and a recorded seismic dataset;
b. bootstrapping a plurality of synthetic angle gathers generated by forward seismic modeling with the well logs, each of the plurality of synthetic angle gathers having an individual angle configuration of a random selection of angles to generate bootstrapped angle gathers;
c. training neural networks using the well logs and the bootstrapped angle gathers as training pairs to build an ensemble of neural networks;
d. preparing seismic angle gathers from the recorded seismic dataset using each of the individual angle configurations to create an ensemble of seismic angle gathers;
e. presenting each of the ensemble of seismic angle gathers to a member of the ensemble of neural networks that was trained with a matching individual angle configuration to generate an ensemble of inversion results; and
f. quantifying uncertainty in the ensemble of inversion results.

2. The method of claim 1 wherein the well logs include at least one of P-wave velocity (Vp), S-wave velocity (Vs), density (ρ), and acoustic impedance (AI).

3. The method of claim 1 wherein the uncertainty is quantified by finding an average inversion result and a standard deviation of the ensemble of inversion results.

4. The method of claim 1 wherein the inversion results are at least one of P-wave velocity (Vp), S-wave velocity (Vs), density (ρ), acoustic impedance (AI), Vₚ/Vₛ ratio, Young's Modulus (E), and Poisson's ratio (v).

5. The method of claim 1 wherein the inversion results are estimated wavelets.

6. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive well logs and a recorded seismic dataset;
b. bootstrap a plurality of synthetic angle gathers generated by forward seismic modeling with the well logs, each of the plurality of synthetic angle gathers having an individual angle configuration of a random selection of angles to generate bootstrapped angle gathers;
c. train neural networks using the well logs and the bootstrapped angle gathers as training pairs to build an ensemble of neural networks;
d. prepare seismic angle gathers from the recorded seismic dataset using each of the individual angle configurations to create an ensemble of seismic angle gathers;
e. present each of the ensemble of seismic angle gathers to a member of the ensemble of neural networks that was trained with a matching individual angle configuration to generate an ensemble of inversion results; and
f. quantify uncertainty in the ensemble of inversion results.

7. The system of claim 6 wherein the well logs include at least one of P-wave velocity (Vp), S-wave velocity (Vs), density (ρ), and acoustic impedance (AI).

8. The system of claim 6 wherein the uncertainty is quantified by finding an average inversion result and a standard deviation of the ensemble of inversion results.

9. The system of claim 6 wherein the inversion results are at least one of P-wave velocity (Vp), S-wave velocity (Vs), density (ρ), acoustic impedance (AI), Vₚ/Vₛ ratio, Young's Modulus (E), and Poisson's ratio (v).

10. The system of claim 6 wherein the inversion results are estimated wavelets.

11. A non-transitory computer readable storage medium storing one or more programs, the one or more programs comprising instructions, which when executed by an electronic device with one or more processors and memory, cause the device to
a. receive well logs and a recorded seismic dataset;
b. bootstrap a plurality of synthetic angle gathers generated by forward seismic modeling with the well logs, each of the plurality of synthetic angle gathers having an individual angle configuration of a random selection of angles to generate bootstrapped angle gathers;
c. train neural networks using the well logs and the bootstrapped angle gathers as training pairs to build an ensemble of neural networks;
d. prepare seismic angle gathers from the recorded seismic dataset using each of the individual angle configurations to create an ensemble of seismic angle gathers;
e. present each of the ensemble of seismic angle gathers to a member of the ensemble of neural networks that was trained with a matching individual angle configuration to generate an ensemble of inversion results; and
f. quantify uncertainty in the ensemble of inversion results.

12. The non-transitory computer readable storage medium of claim 11 wherein the well logs include at least one of P-wave velocity (Vp), S-wave velocity (Vs), density (ρ), and acoustic impedance (AI).

13. The non-transitory computer readable storage medium of claim 11 wherein the uncertainty is quantified by finding an average inversion result and a standard deviation of the ensemble of inversion results.

14. The non-transitory computer readable storage medium of claim 11 wherein the inversion results are at least one of P-wave velocity (Vp), S-wave velocity (Vs), density (ρ), acoustic impedance (AI), Vₚ/Vₛ ratio, Young's Modulus (E), and Poisson's ratio (v).

15. The non-transitory computer readable storage medium of claim 11 wherein the inversion results are estimated wavelets.
